(19) United States
(12) Patent Application Publication
(10) Pub. No.: US 2026/0024111 A1
(43) Pub. Date: Jan. 22, 2026

(54) LATENT INTEREST MODELS

(71) Applicant: VIANT TECHNOLOGY LLC, Irvine, CA (US)

(72) Inventors: Abitha Sivadasan, Dallas, TX (US); Xin Chen, Irvine, CA (US); Fabrizio Blanco, Beverly Hills, CA (US); Tejus Bangalore Krishna, Culver City, CA (US)

(73) Assignee: VIANT TECHNOLOGY LLC, Irvine, CA (US)

(21) Appl. No.: 19/275,477

(22) Filed: Jul. 21, 2025

Related U.S. Application Data
(60) Provisional application No. 63/673,626, filed on Jul. 19, 2024.

(51) Int. Cl. G06Q 30/0251

(52) U.S. Cl. CPC G06Q 30/0254

(57) ABSTRACT

A method and system deliver media content. Multiple first requests for media content are received and first key phrases are extracted into a dictionary. Second media content requests and associated context are collected for media content served to a latent interest audience. The context is used to obtain candidate key phrases. For each of the contexts, the candidate key phrases that match the first key phrases are determined. A subset of the matching candidate key phrases are assigned to the campaign. The subset of matching candidate key phrases is expanded using semantic similarity and stored in a second table. A new media content request that does not include an explicit user identification is received. Based on the new media content request, new request key phrases are determined and compared to the expanded subset. Campaigns with intersections are selected and utilized to deliver media content.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/673,626, filed on Jul. 19, 2024, with inventor(s) Abitha Sivadasan, Xin Chen, Fabrizio Blanco, and Tejus Bangalore Krishna, entitled “Latent Interest Models,” attorneys' docket number 257.0103USP1.

This application is related to the following co-pending and commonly-assigned patent application, which application is incorporated by reference herein:

U.S. patent application Ser. No. 19/218,005, filed on May 23, 2025, by Fabrizio Blanco and Giuseppe Di Mauro, entitled “OUT-OF-HOME INTERNET CONNECTED HOUSEHOLD IDENTIFICATION,” attorneys' docket number 257.0101USC2, which application is a continuation under 35 U.S.C. § 120 of U.S. application Ser. No. 18/610,039 filed on Mar. 19, 2024 (now U.S. Pat. No. 12,341,837 issued on Jun. 24, 2025) with inventor(s) Fabrizio Blanco and Giuseppe Di Mauro, entitled “OUT-OF-HOME INTERNET CONNECTED HOUSEHOLD IDENTIFICATION,” (corresponding to Attorney Docket No.: 257.0101USC1), which application is incorporated by reference herein, and which application is a continuation of U.S. application Ser. No. 17/546,548 (corresponding to Attorney Docket No.: 257.0101US01), filed on Dec. 9, 2021 (now U.S. Pat. No. 11,936,703 issued on Mar. 19, 2024) with inventor(s) Fabrizio Blanco and Giuseppe Di Mauro, entitled “OUT-OF-HOME INTERNET CONNECTED HOUSEHOLD IDENTIFICATION,” which application is incorporated by reference herein.

### BACKGROUND OF THE INVENTION

### 1. Field of the Invention

The present invention relates generally to identifying Internet users without a deterministic identification or categorization, and in particular, to a method, system, apparatus, and article of manufacture for targeting media content consumers/users without the use of traditional user identifiers or categorization.

### 2. Definitions/Description of the Related Art

When users browse the Internet and/or media content, users (and/or their devices) may often be identified using traditional identifiers such as cookies, mobile advertising identifiers (MAIDs), and internet protocol (IP) addresses. However, due to data privacy concerns (e.g., adopted by browsers/operating systems and/or industry wide regulations), the use of such traditional identifiers may be limited, impermissible, or unavailable. As a result, third-party audience segments may see lower addressability leading to poor targeting outcomes as such targeting commonly rely on cross-site tracking. Accordingly, prior art systems fail to provide mechanism/methodology to target audience segments effectively without relying solely on the presence of audience attributes associated with a deterministic identification (ID). To better understand such problems, a description of internet communication protocols and cookies may be useful.

### Internet Protocol Address (IP)

An IP address is a logical address for a network adapter. Generally speaking, an IP address uniquely identifies computers on a TCP/IP network (transmission control protocol/Internet protocol network).

An IP address can be private—for use on a local area network (LAN)—or public—for use on the Internet or other wide area network (WAN). IP addresses can be determined statically (assigned to a computer by a system administrator) or dynamically (assigned by another device on the network on demand).

Two IP addressing standards are in use today. The IPV4 standard is most familiar to people and supported everywhere on the Internet. The IPV6 standard is the successor to IPv4 and is used to perform various addressing and routing methodologies including unicast addressing, anycast addressing, and multicast addressing.

IPv4 addresses consist of four bytes (32 bits). Each byte of an IP address is known as an octet. Octets can take any value between 0 and 255. Various conventions exist for the numbering and use of IP addresses. IPv6 addresses consist of 16 bytes (128 bits), and as such has an enlarged address space compared to that of IPV4.

### Transmission Control Protocol/Internet Protocol (TCP/IP)

TCP/IP is the communication protocol for the Internet. A computer communication protocol is a description of the rules computers must follow to communicate with each other. TCP/IP defines how electronic devices (like computers) should be connected to the Internet, and how data should be transmitted between them. Each computer must have an IP address before it can connect to the Internet and each IP packet must have an address before it can be sent to another computer.

### Hypertext Transfer Protocol (HTTP)

The Hypertext Transfer Protocol provides a standard for Web browsers and servers to communicate. HTTP is an application layer network protocol built on top of TCP. HTTP clients (such as Web browsers) and servers communicate via HTTP request and response messages.

### Cookies

Other identifiers may also be referenced upon a media content/advertising call aside from an IP address. For example, upon a request for media content/advertising, a publisher-generated 1^{st} party cookie may be provided. The purpose of this 1^{st} party cookie identifier is for a publisher to be able to manage reach/frequency at the user level when the user visits the publisher's property/website multiple times. The 1^{st} party cookie is unique to the domain (e.g., www.cnn.com) and is not the same as the 3^{rd} party cookie, which is in decline. The 1^{st} party cookie is defined by the publisher and passed through upon advertising calls via an SSP (supply-side platform—software that is used to sell advertising in an automated fashion). SSPs are most often used by online publishers to help them sell display, video and mobile ads.

There are various prior art examples that provide a publisher ID/1^{st} party cookie solution. For example, the GOOGLE's AD MANAGER 360 provides a publisher provided identifier (PPID) that allows publishers to send through an identifier to use in frequency capping, audience segmentation/targeting, sequential ad rotation, and other audience-based ad delivery controls across devices. In another example, APPLE's IDENTIFIER FOR VENDOR (IDFV) provides for a 1^{st} party ID for a vendor where the value of the property is the same for apps that come from the same vendor running on the same device.

In contrast to 1^{st} party cookies, 3^{rd} party cookies are small text files that websites other than the one a user is currently visiting can place on the user's device. 3^{rd} party cookies are often embedded through advertisements, analytics scripts, or social media widgets on a website and store information about the user's browsing behavior, allowing websites to track a user's activity across the Internet. In this regard, when a user visits a website that includes content from a third-party (e.g., an ad network), the third party sets a cookie on the user's device. When the user visits other websites that also sue that same third-party, the third party can read the cookie and track the user's activity.

Many web browsers and operating systems (e.g., mobile phone operating systems) as well as broader industry-wide regulations relating to data privacy may restrict/eliminate the ability to use 3^{rd} party cookies. Further, users may opt out of the use of 3^{rd} party cookies resulting in a cookieless environment. Such deprecation of 3^{rd} party cookies is not specific to web-browsing traffic but pertains to other communications/traffic such as video (e.g., streaming/satellite based transmissions of video content), desktop communications (e.g., users communicating with each other via software applications such as instant messaging, voice calls, video conferencing, screen sharing, etc.), audio (e.g., streaming based audio services), CTV (connected television), etc.

### Bidstream

In the world of programmatic advertising, a bidstream deterministic ID refers to an identifier used in the bidstream, the real-time data sent out during programmatic advertising auctions, that is based on explicitly known user data. This type of ID is highly accurate because it links an individual's digital activity across various devices and sessions using data like email addresses, phone numbers, or login credentials that a user has provided and consented to. Deterministic IDs primarily rely on first-party data, meaning data collected directly by a publisher or advertiser from their users through logins or registration. Since it is deterministic based on logins or user registration, accuracy is ensured such that the same user can be identified (via the ID) across different devices and the user's experience can be tailored/personalized to the user. However, as described above, users must consent and increasingly, users are opting-out of the use of such deterministic IDS.

### Problem Overview

In view of the above, it is desirable to enable the delivery of media content to specific users (e.g., target audiences) effectively without the use of traditional identifiers (e.g., 3^{rd} party cookies and/or deterministic IDs). In other words, it is desirable to provide a mechanism/method/technique to target effectively without relying solely on the presence of audience attributes associated with a deterministic ID (e.g., within a bidstream). Further, it is desirable for entities to remain independent from (i.e., less dependent on) 3^{rd} parties (e.g., GOOGLE™) while addressing ID loss beyond just the use of 3^{rd} party cookies.

### SUMMARY OF THE INVENTION

Latent interest models provide a solution to personalize/customize content to users (e.g., via targeting) without reliance on IDs in a bidstream. Embodiments of the invention leverage the context from the bidstream to identify co-occurring content signals to build a propensity network a priori. Advantages of such approach lie in the fact that while building this network requires a cohort of deterministic IDS, personalizing media content to users does not. Hence, all bid requests including ones that cannot be bid on (e.g., due to the lack of appropriate audience signals) may be opened up for bidding, not to mention ID-less personalization/targeting.

Latent Interest Models extend beyond simple contextual targeting by identifying latent propensities based on observations over time, rather than based on a single event. Third party contextual data providers use simple contextual signals such as these, and also have some degree of involvement from cross-site tracking under-the-hood. Exemplary uses include display and online video targeting.

### BRIEF DESCRIPTION OF THE DRAWINGS

Referring now to the drawings in which like reference numbers represent corresponding parts throughout:

FIG. 1 illustrates the component architecture and data flow for utilizing a latent interest model (LIM) in accordance with one or more embodiments of the invention;

FIG. 2 illustrates the logical flow methodology for delivering media content through the component architecture of FIG. 1 in accordance with one or more embodiments of the invention;

FIG. 3 illustrates an exemplary propensity network in accordance with one or more embodiments of the invention;

FIG. 4 illustrates an exemplary advertising/media content delivery system/architecture utilized in accordance with one or more embodiments of the invention;

FIG. 5 is an exemplary hardware and software environment used to implement one or more embodiments of the invention; and

FIG. 6 schematically illustrates a typical distributed/cloud-based computer system utilized in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Problem Overview

Without deterministic IDs, the ability to customize/personalize media content that is delivered to a user may be limited. For example, frequency capping (a limit to how often a single user sees media/content/an advertisement during a specific time period) and frequency measurement (the rate/average number of times a user sees a particular piece of media content/advertisement within a specific time period) become challenging with ID-less targeting. While IP addresses exist, it may still be possible to measure HH (household) reach and cap at the HH level. The ability to measure HH reach is further described in related patent application Ser. No. 19/218,005, filed on May 23, 2025 that is cross-referenced above. Further, embodiments of the invention consider ways to become self-reliant in ID-less targeting and an increase in 3rd party (3P) cookie deprecation.

### Latent Interest Model Data Flow

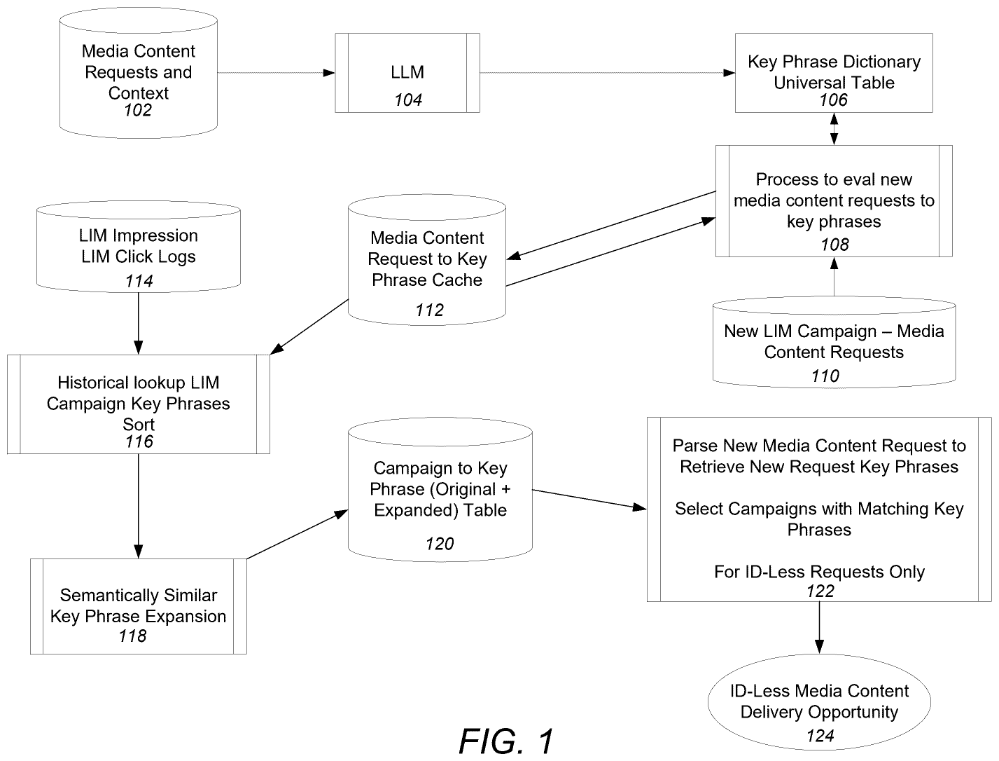

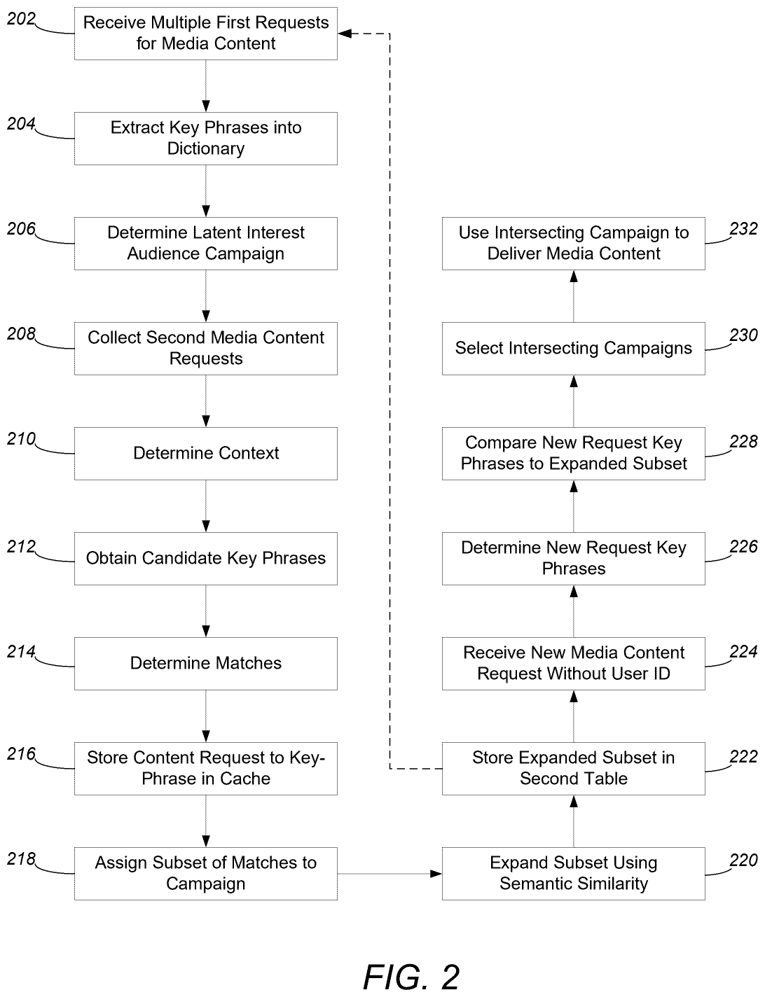

FIG. 1 illustrates the component architecture and data flow for utilizing a latent interest model (LIM) in accordance with one or more embodiments of the invention. FIG. 2 illustrates the logical flow methodology for delivering media content through the component architecture of FIG. 1 in accordance with one or more embodiments of the invention. Embodiments of the invention are described below while referencing the steps of FIG. 2 and component architecture of FIG. 1.

At step 202, multiple first requests for media content are received. The multiple first requests may also include the context for the request (i.e., media content requests and context 102). In one or more embodiments, the multiple first requests may consist of uniform resource locators (URLs) and the context would be obtained by crawling the content of the URL or extracted directly from the URL (if the URL contains phrases that describe the specific page content). Similarly, if the request is for audio-video, the context may consist of the transcript of the audio-video and or information/metadata about the content of the video.

At step 204, one or more first key phrases are extracted (e.g., using a large language model [LLM] 104) into a dictionary 106 (referred to in FIG. 1 as the key phrase dictionary universal table). Thus, first key phrases are extracted from the multiple first requests for media content (or from the media content itself—i.e., the context of the request) 102. In this regard, the dictionary 106 is the universal set of possible key phrases that will be used as tokens. Using NETFLIX™ as an analogy, step 204 would tag (i.e., extract key phrases) movies as “gritty action,” “90's romance,” “classic western action,” etc. In one or more embodiments, new key phrases are collected/extracted on a predefined time basis (e.g., daily). The URLs that are visited by users, the content of the URLs, the audio transcripts of videos, etc., are all data fed into the LLM 104 (e.g., a BERT [bi-directional encoder representations and transformers] transformer) that will analyze and extract key phrases.

In one or more embodiments, the extracting the one or more first key phrases step 204 extracts the one or more first key phrases off-line using a first large language model (LLM) 104 to analyze historical media content requests to build the dictionary 106 of key phrases.

In addition, in step 106, the key phrases may be de-duplicated/cleaned up on a different predefined time basis (e.g., monthly) and stored in the universal table 106. In other words, the one or more first key phrases in the dictionary 106 are regularly de-duplicated on a predefined time period.

At step 206, a determination is made that a campaign will be utilizing a latent interest audience. For example, a campaign may opt into the latent interest audience/use of the latent interest model.

At step 208, second media content requests 110 are collected. More specifically, after a campaign has opted into the latent interest audience (at step 206), the second media content requests 110 (e.g., URLs on impressions) served to a defined audience are collected (at step 208). After a “critical mass” (e.g., a threshold number of media content (e.g., impressions) are delivered/seen by the audience, the process continues.

Once a crucial mass threshold number of media content/impressions have been seen, at step 108, the new LIM campaign media content requests 110 (also referred to as the second media content requests) are processed for evaluation. More specifically, step 108 corresponds to steps 210-216 of FIG. 2. At step 210, the context of the second media content requests 110 is determined. For example, when the second media content requests 110 consists of URLs, the URLs may be crawled to download content (i.e., wherein the context consists of the downloaded content) or extracted directly from the URL (if the URL contains phrases that describe the specific page content). Alternatively, if the second media content requests 110 are for audio/video, the transcripts (that make up the context) may be obtained.

At step 212, candidate key phrases from each of the contexts is obtained. In one or more embodiments the context may be split into n-gram phrases (e.g., 2-word, 3-word, 4-word, 5-word, etc.) in order of occurrence to obtain candidate key phrases.

At step 214, for each of the contexts, the candidate key phrases that match one or more first key phrases in the dictionary are determined. At step 216, content requests with matching key phrases are stored in the media content request to key phrase cache 112. In other words, the candidates are compared against the universal table 106 at 214, and only those key phrases that are present in the universal table 106 are stored in the content request to key phrase cache 112. Thus, the “media content to request to key phrase cache” 112 is a table of media content requests (e.g., URLs) that serve as keys that are mapped to the key phrases found inside that media content request/context. Thus, embodiments of the invention store, in the cache 112, a first table that maps each of the second media content requests to the matching candidate key phrases.

At step 218, a subset of the matching candidate key phrases is assigned to the media content delivery campaign. In other words, the media content request to key phrase assignment process is performed for all campaigns that are utilizing (e.g., have opted into) the latent interest audience (as determined at step 206).

To determine the subset at step 218, in one or more additional embodiments, at process 116, for each entry in the cache 112, the matching candidate key phrases are sorted/ranked based on key performance index (KPI) data. Based on the sorting, the subset comprises the top n-matching candidate key phrases. For example, using impressions, the URL source of the impressions, and KPI data for up to thirty (30) days of history, the key phrases may be ranked in descending order of KPI. In one or more embodiments, the KPI may be based on whether the media content/impression was served/delivered/clicked (e.g., based on LIM impression and/or LIM click logs 114). For example, if a key phrase is found in an impression and found in a click (e.g., of the impression), both an impression count and click count may be increased. Alternatively, if a key phrase is found in an impression but not in a click, the impression count may be increased but not the click count. In such an example, the KPIs may consist of click rate and/or impression served rate. Thereafter, the top n key phrases (e.g., top 200 key phrases) may be selected and assigned to the campaign.

Step 220 (corresponding to process 118) provides for an expansion of the subset of matching candidate key phrases based on/using semantic similarity. In one or more embodiments, the expansion is performed utilizing a second LLM. Thus at step 220/118, each matching candidate key phrase is expanded to up to m new candidate key phrases. An analogy would be using an LLM to expand “prince harry and meghan markle” to “British royals,” and/or “taylor swift boyfriend” to “travis kelce”. In this regard, the expansion 118/220 may update not just based on history but also based on recent trending searches, for example.

At step 222, the original matching candidate key phrases and the “expanded” matching candidate key phrases are then stored in a second table 120 indexed/keyed by the media content delivery campaign.

Steps 202-222 may then be repeated for additional media content delivery campaigns (e.g., for all media content delivery campaigns that are utilizing latent interest audience functionality).

At step 224, a new media content request without an explicit user identification is received.

At step 226, based on the new media content request, new request key phrases are determined. In other words, at step 226/122, the new media content request is parsed to retrieve new request key phrases. For example, the source URL may be broken down into key phrases (e.g., based on n gram key phrases). Alternatively, in the case of video/audio content, an offline look-up of the content ID may be conducted.

At step, 228, the new request key phrases are compared to the expanded subset (i.e., the original and expanded table 120). For example, an n-gram comparison of the new request key phrases to the key phrases in table 120 may be conducted.

At step 230, based on the comparison at step 228, campaigns are selected where there is an intersection. The selected campaigns become eligible for serving their media content in the absence of explicit user identification thereby expanding the reach of the campaign.

Accordingly, at step 232, the intersecting campaigns are used to deliver media content in response to the new request.

To perform steps 224-232 (e.g., via process 122) embodiments may copy table 120 to servers (e.g., advertising servers) (e.g., using an FTP [file transfer protocol] or other copy mechanism). When media content delivery opportunities (e.g., a real-time bid [RTB] ad opportunity) without user-ID is presented to the server, the source identifier of the media content (e.g., the media content request such as a URL or a content-ID of audio/video) is also received. This media content request/identifier may then be parsed into n-gram key phrases (e.g., at step 228).

Step 232 may further provide for maintaining a log of the media content that is delivered using latent interest. For example, advertisements/media content served using latent interest may be tagged in the logs. Based on the log, step 232 may also include the ability to perform advanced reporting and/or provide a feedback loop to maintain (media content delivery) quality.

### Exemplary Use Cases

### Assumptions

Embodiments of the invention may reuse pre-processing steps (e.g., the extraction of key phrases step 204) from a page content classification model provided by a machine learning (ML) team of the assignee of the present invention (e.g., use of a BERT transformer LLM). A keyword propensity model may also be utilized that is based on a pre-processed set of URLs (uniform resource locators) and associated IDs from a truth set cohort consisting of MAIDs (mobile advertising identifier) and IPs (internet protocols) from a device graph, that can be backed up to a physical address. Sitelist functionality (i.e., the ability to manage and configure how websites are handled within an internet browser—e.g., when dealing with compatibility issues or specific browser preferences) may also be repurposed within a runtime environment to extend to keyword/contextual targeting.

As used herein, a device graph is a data structure that anonymously links individuals to their personal devices. Device graphs collect continuous inputs from many different data streams, and this data is categorized, organized, and validated to provide a more complete picture of each household—and the multiple devices in it.

As the use of cookies deprecates, media content providers may start to see declining targeting outcomes (e.g., if/as GOOGLE limits the use of cookies, it may result in a low availability of CHROME browser inventory other than via direct deals—in this regard, the CHROME web browser being the predominant browser in use will most likely have a significant enough impact to outcomes that clients monitor (e.g., clickthrough and conversion)).

Embodiments of the invention compare the performance of orders (e.g., for the purchase of media content/advertisements) with and without LIM (latent interest models) enabled to determine the percentage improvement in (1) unfulfilled demand; and (2) CTR (click through rate).

### Audience Extension

One or more embodiments of the invention use LIM for audience extension for select client media content/advertising campaigns that are facing challenges in fulfilling demand. In such embodiments, LIM can be turned on (e.g., at step 206) for select campaigns (e.g., for the purpose of testing or use). To provide such capabilities, a propensity network (as described in further detail below) may be generated and kept updated via weekly updates. Such a propensity network may be initially generated based on a set of IDs from a graph (e.g., a device graph that may include IP and MAIDs) that is backed to a physical address based on HH ID (as described in the related case cross-referenced above) to ensure high fidelity signals to the model. However, embodiments of the invention may swap out such a truth set cohort to something else should one become available via direct partnerships with publishers/advertisers/consortiums. Further, embodiments of the invention may ensure sufficient logging of signals to logs: (a) to determine the impressions delivered against the original targeting segments vs. the extended audience via LIM; and (b) to lookup the keywords determined based on the propensity network to understand the inner-workings of the LIM approach.

### Propensity Network

As described herein, the propensity network refers to the campaign to key phrase (original+expanded) table 120 of FIG. 1. In other words, it refers to the propensity or inclination of a device/user to behave in a certain way. The concept is to predict the likely propensity of an ID-less user/device based on similarities between the ID-less user/device and ID′d users. Table 120 is generated and maps campaigns to keywords/key phrases. When a request for new ID-less user/device comes in, keywords/key phrases from the ID-less user/device request is compared to those in table 120 to find matches which provide the projected behavior propensity of the ID-less user/device. In other words, if matching keywords/key phrases can be identified between ID-less users and those in the table 120 (i.e., of campaign to key phrases), then the same campaign can be used to address the ID-less users.

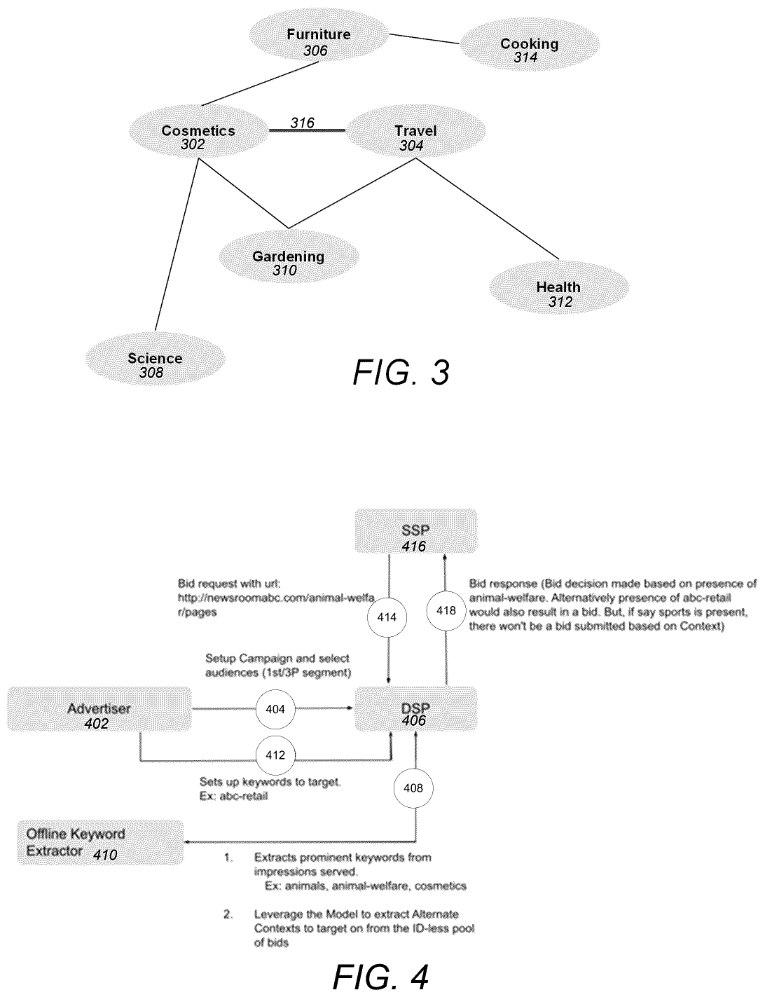

Using a cohort of deterministic IDs, an (LLM) model may generate the propensity network. The cohort can be a set of active device-IDs seen in the last ten (10) days that are backed up to a physical address into a device graph. FIG. 3 illustrates an exemplary propensity network in accordance with one or more embodiments of the invention. As illustrated, in an exemplary embodiment there is a small cohort of three (3) IDs 302, 304, and 306. The three cohorts 302-306 have respective keyword vectors 308-314 (e.g., also referred to as key phrases) generated using URL keywords from signals where these IDs 302-306 were seen in the bidstream. More specifically:
ID-1: Cosmetics 302, Science 308, Furniture 306, Travel 304
ID-2: Travel 304, Gardening 310, Health 312, Cosmetics 302
ID-3: Furniture 306, Cooking 314

In the network shown in FIG. 3, Cosmetics 302 and Travel 304 have a stronger edge 316 than other keyword pairs, thereby representing a higher propensity to co-occur (reflected in FIG. 3 as a thicker line 316). Over time, the weaker connections will get pruned, leaving out the strong links representing strong propensities to co-occur. When an audience is selected for targeting (either first or third party), the propensity network is cross-referenced to determine alternate contexts to advertise on. For example, if a critical majority of IDs in a campaign's target segment show up in pages with a Cosmetics 302 content, the target audience may be extended to include the Travel 304 context, thereby opening up Travel 304 related sites for the ads in this campaign. Feedback from the effects of this extension, in terms of changes to CTR (click thru rate) and conversions may be used to adjust the propensity network over time.

The creation of the propensity network may happen a-priori and is independent of any action from users (managed service or customer). The steps for creating the propensity network are:
(1) Selecting a set of deterministic IDs from the device graph that is backed with a household ID within the device graph, thereby providing a high fidelity truth set for the propensity network creation. Deterministic IDs (e.g., in a device graph) can be MAIDs and IPs.
(2) Processing bidstream data to generate clean URLs or keyword/key phrase vectors;
(3) Generating the propensity network based on co-occurrence of keywords/key phrases on the IDs and relative frequency to determine strength of the connections.

If a different truth set becomes available at a later time (e.g., via a direct partnership with a panel vendor), the cohort from (1) (the set of deterministic IDs) may be replaced and the process may be rerun to create a new propensity network.

In one or more embodiments, the propensity network is built using campaign data from a DSP or SSP as the training set. However, there is also a component of the latent interest model that relies on picking up keywords/key phrases that resonate with the campaign on hand. Such a component doesn't rely on training using a training set from prior data. Instead, such a component is essentially learning as the campaign is in progress to learn the most resonant keywords/key phrases. It then extends the found keywords/key phrases to more keywords/key phrases using the propensity network's keywords/key phrases.

Based on the propensity network, embodiments of the invention provide latent interest based targeting that may be utilized as follows:
(1) The process kicks off after a user has set up their media content delivery/advertising campaigns and selected their targeting criteria and segments (1st, 2nd 3rd party to the extent available).
(2) Once a sufficient number of IDs have been targeted (e.g., empirically or defined via a threshold value), the highest occurrence keywords/key phrases are determined from URLs within the ad-logs.
(3) The propensity network is examined to determine related keywords/key phrases to the keyword(s)/key phrase(s) from (2).
(4) When a new bid request arrives, the DSP will look for the presence of the keywords/key phrases from (2) and (3) on impressions that either do not have an ID, or have an ID but no eligible segments.

To maximize outcomes, embodiments of the invention may check the quality of keywords/key phrases from steps (2) and (3) above. Another factor that may be considered is the audience extension ratio and if demand has been met. Further, embodiments of the invention may take active steps to ensure that the outcome measures from use of LIMs compare to a baseline without extension/use of LIM.

### Campaign Setup/Architecture

FIG. 4 illustrates an exemplary advertising/media content delivery system/architecture utilized in accordance with one or more embodiments of the invention. At step 402, advertiser 404 sets up (i.e., on a demand side platform 406) an advertising/media content delivery campaign and selects target audiences (e.g., 1^{st}/3P segment).

At step 408, the DSP 406, utilizes an offline keyword/key phrase extractor 410 to extract prominent keywords/key phrases from impressions/media content served (e.g., animals, animal-welfare, cosmetics), and leverages the model to extract alternate contexts to target on from the ID-less pool of bids. In this regard, keywords/key phrases may be extracted by observing most-seen keywords/key phrases in bidstream URLs associated with impressions served. Alternatively, keywords/key phrases may be configured at campaign setup time 412 (e.g., by advertiser 402 setting up keywords/key phrases to target such as abc-retail). Alternate keywords to those detected/provided may be determined using LIM (e.g., as described above with respect to FIGS. 1 and 2).

At step 414, the DSP 406 receives a bid request with a media content identifier (e.g., a URL such as http://newsroomabc.com/animal-welfare/pages) from a server-side platform (SSP) 416.

At step 418, in response to the bid request, the DSP 406 sends the bid response to SSP 416. The bid response may consist of a bid decision made based on the presence of key phrases extracted from the bid request (e.g., “animal-welfare”). Alternatively, based on semantic similarities (or based on the propensity network), the presence of alternative key phrases (e.g., “abc-retail”) may also result in a bid. However, if unrelated key phrases are present in the media content (e.g., “sports”), a bid may be not be submitted (e.g., based on context).

Results from the media content/advertisement delivery may be logged to provide metrics for evaluating embodiments of the invention. For example, one exemplary metric may be “ID-less bid volume across all browser and device types” that provides the volume of ID-less bids. Data from such a metric (e.g., showing an IP address with no other ID in 20% of bid requests) may be added to a log for weekly monitoring by pulling from RTB bid data tables. Another exemplary metric may be “adoption” that provides a qualitative measure of success with extending reach with managed latent interest model services. A further exemplary metric may be “scale extension” that provides the number of net new bids that became eligible compared to prior situations where no bids were eligible (e.g., compared to the number of original bid count for a campaign) (e.g., determined using offline testing). Another exemplary metric may be “accuracy of keywords for audience prediction” that measures the overlap between eligible bids discovered using keywords and all bids in a test set (e.g., determined using offline testing).

Further to the above, step 206 may provide the capability for enabling the use of latent interest models/modeling (LIM) (e.g., using a latent interest audience campaign). Such capabilities may be optional to advertisers/media content providers on a per campaign basis (i.e., at the campaign level) with a default setting turned “off” for using LIM. When enabled, embodiments of the invention will enable bidding on ID-less inventory/ID′d ineligible inventory, using LIM. In this regard, when enabled, embodiments of the invention may (a) determine the prominent keywords/key phrases associated with the impressions delivered on a campaign; (b) find keywords/key phrases associated with keywords/key phrases found in (a) from the propensity network; and (c) target impressions during runtime that have URLs with the keywords/key phrases determined in (b). To ensure equitable distribution of impressions across available original segment impressions and the extended keywords/key phrases, embodiments may provide a settable throttling of bids on an extended audience (e.g., the extended audience may be roughly one in every N bids).

Additional embodiments of the invention may provide the ability to estimate the household reach. For example, it may be desirable to understand the household reach of a campaign across contextual ID-less impressions and ID based impressions alike. Such embodiments may update the household reach shown in campaign related screens to be the estimated reach based on extrapolating household reach on deterministic IDS over the total impressions across ID′d and ID-less impressions. The forecasted household reach may then be updated using a projected reach approach. For example, projections may be based on simple linear projects or may be modeled using campaign metadata.

A further metric utilized in embodiments of the invention may be estimated frequency that measures the frequency of campaigns across ID-less impressions and ID-based impressions alike. Such an estimated frequency metric may be updated using a deterministic cohort of users.

An estimated household reach metric may be utilized to understand the household reach of campaigns across ID-less impressions and ID-based impressions alike. Such an estimated household reach may be updated based on extrapolating HH reach on deterministic IDs over the total impressions across ID′d and ID-less impressions. Similarly, a forecasted HH reach may be updated using a projected reach approach.

### Hardware Environment

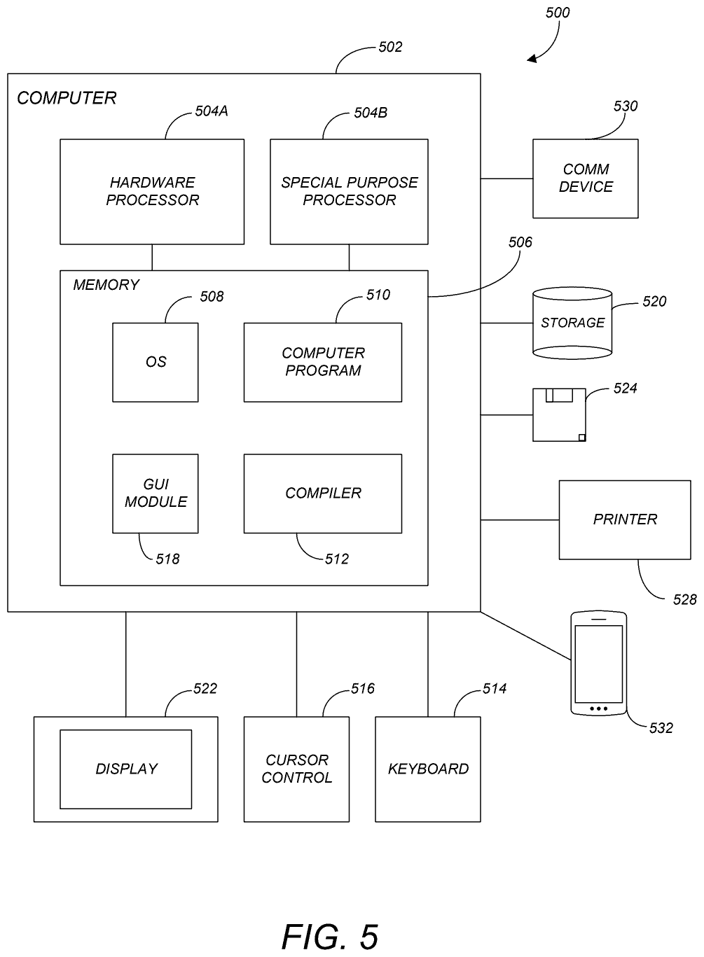

FIG. 5 is an exemplary hardware and software environment 500 (referred to as a computer-implemented system and/or computer-implemented method) used to implement one or more embodiments of the invention. The hardware and software environment includes a computer 502 and may include peripherals. Computer 502 may be a user/client computer, server computer, or may be a database computer. The computer 502 comprises a hardware processor 504A and/or a special purpose hardware processor 504B (hereinafter alternatively collectively referred to as processor 504) and a memory 506, such as random access memory (RAM). The computer 502 may be coupled to, and/or integrated with, other devices, including input/output (I/O) devices such as a keyboard 514, a cursor control device 516 (e.g., a mouse, a pointing device, pen and tablet, touch screen, multi-touch device, etc.) and a printer 528. In one or more embodiments, computer 502 may be coupled to, or may comprise, a portable or media viewing/listening device 532 (e.g., an MP3 player, IPOD, NOOK, portable digital video player, cellular device, personal digital assistant, etc.). In yet another embodiment, the computer 502 may comprise a multi-touch device, mobile phone, gaming system, internet enabled television, television set top box, or other internet enabled device executing on various platforms and operating systems.

In one embodiment, the computer 502 operates by the hardware processor 504A performing instructions defined by the computer program 510 (e.g., a computer-aided design [CAD] application) under control of an operating system 508. The computer program 510 and/or the operating system 508 may be stored in the memory 506 and may interface with the user and/or other devices to accept input and commands and, based on such input and commands and the instructions defined by the computer program 510 and operating system 508, to provide output and results.

Output/results may be presented on the display 522 or provided to another device for presentation or further processing or action. In one embodiment, the display 522 comprises a liquid crystal display (LCD) having a plurality of separately addressable liquid crystals. Alternatively, the display 522 may comprise a light emitting diode (LED) display having clusters of red, green and blue diodes driven together to form full-color pixels. Each liquid crystal or pixel of the display 522 changes to an opaque or translucent state to form a part of the image on the display in response to the data or information generated by the processor 504 from the application of the instructions of the computer program 510 and/or operating system 508 to the input and commands. The image may be provided through a graphical user interface (GUI) module 518. Although the GUI module 518 is depicted as a separate module, the instructions performing the GUI functions can be resident or distributed in the operating system 508, the computer program 510, or implemented with special purpose memory and processors.

In one or more embodiments, the display 522 is integrated with/into the computer 502 and comprises a multi-touch device having a touch sensing surface (e.g., track pod, touch screen, smartwatch, smartglasses, smartphones, laptop or non-laptop personal mobile computing devices) with the ability to recognize the presence of two or more points of contact with the surface. Examples of multi-touch devices include mobile devices (e.g., IPHONE, ANDROID devices, WINDOWS phones, GOOGLE PIXEL devices, NEXUS S, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 502 according to the computer program 510 instructions may be implemented in a special purpose processor 504B. In this embodiment, some or all of the computer program 510 instructions may be implemented via firmware instructions stored in a read only memory (ROM), a programmable read only memory (PROM) or flash memory within the special purpose processor 504B or in memory 506. The special purpose processor 504B may also be hardwired through circuit design to perform some or all of the operations to implement the present invention. Further, the special purpose processor 504B may be a hybrid processor, which includes dedicated circuitry for performing a subset of functions, and other circuits for performing more general functions such as responding to computer program 510 instructions. In one embodiment, the special purpose processor 504B is an application specific integrated circuit (ASIC).

The computer 502 may also implement a compiler 512 that allows an application or computer program 510 written in a programming language such as C, C++, Assembly, SQL, PYTHON, PROLOG, MATLAB, RUBY, RAILS, HASKELL, or other language to be translated into processor 504 readable code. Alternatively, the compiler 512 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 510 accesses and manipulates data accepted from I/O devices and stored in the memory 506 of the computer 502 using the relationships and logic that were generated using the compiler 512.

The computer 502 also optionally comprises an external communication device such as a modem, satellite link, Ethernet card, or other device for accepting input from, and providing output to, other computers 502.

In one embodiment, instructions implementing the operating system 508, the computer program 510, and the compiler 512 are tangibly embodied in a non-transitory computer-readable medium, e.g., data storage device 520, which could include one or more fixed or removable data storage devices, such as a zip drive, floppy disc drive 524, hard drive, CD-ROM drive, tape drive, etc. Further, the operating system 508 and the computer program 510 are comprised of computer program 510 instructions which, when accessed, read and executed by the computer 502, cause the computer 502 to perform the steps necessary to implement and/or use the present invention or to load the program of instructions into a memory 506, thus creating a special purpose data structure causing the computer 502 to operate as a specially programmed computer executing the method steps described herein. Computer program 510 and/or operating instructions may also be tangibly embodied in memory 506 and/or data communications devices 530, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 502.

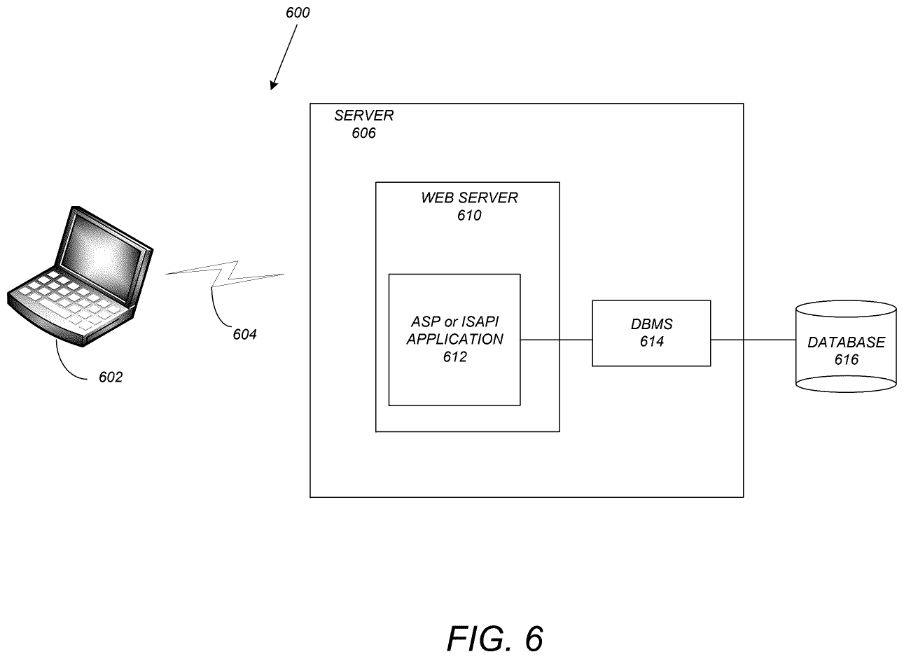

FIG. 6 schematically illustrates a typical distributed/cloud-based computer system 600 using a network 604 to connect client computers 602 to server computers 606. A typical combination of resources may include a network 604 comprising the Internet, LANs (local area networks), WANs (wide area networks), SNA (systems network architecture) networks, or the like, clients 602 that are personal computers or workstations (as set forth in FIG. 5), and servers 606 that are personal computers, workstations, minicomputers, or mainframes (as set forth in FIG. 5). However, it may be noted that different networks such as a cellular network (e.g., GSM [global system for mobile communications] or otherwise), a satellite based network, or any other type of network may be used to connect clients 602 and servers 606 in accordance with embodiments of the invention.

A network 604 such as the Internet connects clients 602 to server computers 606. Network 604 may utilize ethernet, coaxial cable, wireless communications, radio frequency (RF), etc. to connect and provide the communication between clients 602 and servers 606. Further, in a cloud-based computing system, resources (e.g., storage, processors, applications, memory, infrastructure, etc.) in clients 602 and server computers 606 may be shared by clients 602, server computers 606, and users across one or more networks. Resources may be shared by multiple users and can be dynamically reallocated per demand. In this regard, cloud computing may be referred to as a model for enabling access to a shared pool of configurable computing resources.

Clients 602 may execute a client application or web browser and communicate with server computers 606 executing web servers 610. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 602 may be downloaded from server computer 606 to client computers 602 and installed as a plug-in or ACTIVEX control of a web browser. Accordingly, clients 602 may utilize ACTIVEX components/component object model (COM) or distributed COM (DCOM) components to provide a user interface on a display of client 602. The web server 610 is typically a program such as MICROSOFT'S INTERNET INFORMATION SERVER.

Web server 610 may host an Active Server Page (ASP) or Internet Server Application Programming Interface (ISAPI) application 612, which may be executing scripts. The scripts invoke objects that execute business logic (referred to as business objects). The business objects then manipulate data in database 616 through a database management system (DBMS) 614. Alternatively, database 616 may be part of, or connected directly to, client 602 instead of communicating/obtaining the information from database 616 across network 604. When a developer encapsulates the business functionality into objects, the system may be referred to as a component object model (COM) system. Accordingly, the scripts executing on web server 610 (and/or application 612) invoke COM objects that implement the business logic. Further, server 606 may utilize MICROSOFT'S TRANSACTION SERVER (MTS) to access required data stored in database 616 via an interface such as ADO (Active Data Objects), OLE DB (Object Linking and Embedding DataBase), or ODBC (Open DataBase Connectivity).

Generally, these components 600-616 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 602 and 606 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 602 and 606. Embodiments of the invention are implemented as a software/CAD application on a client 602 or server computer 606. Further, as described above, the client 602 or server computer 606 may comprise a thin client device or a portable device that has a multi-touch-based display.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for delivering media content, comprising:
receiving multiple first requests for media content;
extracting, into a dictionary, one or more first key phrases from the multiple first requests for media content or from the media content itself;
determining that a media content delivery campaign will apply to a latent interest audience;
collecting second media content requests for media content served to the latent interest audience;
determining a context for each of the second media content requests;
obtaining candidate key phrases from each of the contexts;
for each of the contexts, determining the candidate key phrases that match the one or more first key phrases in the dictionary;
storing, in a cache, a first table that maps each of the second media content requests to the matching candidate key phrases;
assigning a subset of the matching candidate key phrases to the media content delivery campaign;
expanding the subset of matching candidate key phrases using semantic similarity;
storing the expanded subset of matching candidate key phrases in a second table indexed by the media content delivery campaign;
repeating the above for one or more additional media content delivery campaigns;
receiving a new media content request that does not include an explicit user identification;
determining, based on the new media content request, new request key phrases;
comparing the new request key phrases to expanded subset of matching candidate key phrases in the second table to determine intersections;
selecting media content delivery campaigns where there are intersections; and
utilizing one of the selected media content delivery campaigns to deliver media content in response to the new media content request.

2. The computer-implemented method of claim 1, wherein each of the multiple first requests for media content comprises a uniform resource locator (URL) request.

3. The computer-implemented method of claim 1, wherein each of the multiple first requests for media content comprises a request for audio or video content.

4. The computer-implemented method of claim 1, wherein the extracting the one or more first key phrases comprises:
extracting the one or more first key phrases off-line using a first large language model (LLM) to analyze historical media content requests to build the dictionary of key phrases.

5. The computer-implemented method of claim 1, further comprising:
regularly de-duplicating the one or more first key phrases in the dictionary on a predefined time period.

6. The computer-implemented method of claim 1, wherein:
the second media content requests comprise uniform resource locator (URL) requests;
the determining the context comprises crawling content of the URL in the URL request.

7. The computer-implemented method of claim 1, wherein:
the second media content requests comprise requests for audio-video content; and
the determining the context comprises obtaining transcripts of the audio-video content.

8. The computer-implemented method of claim 1, further comprising:
for each entry in the cache, sorting the matching candidate key phrases based on key performance index (KPI) data, wherein, based on the sorting, the subset comprises a top n matching candidate key phrases.

9. The computer-implemented method of claim 1, wherein the expanding utilizes a second LLM.

10. The computer-implemented method of claim 1, further comprising:
maintaining a log of the media content that is delivered using latent interest;
based on the log, providing a feedback loop to maintain media content delivery quality.

11. A computer-implemented system for delivering media content comprising:
(a) a computer having a memory;
(b) a processor executing on the computer;
(c) the memory storing a set of instructions, wherein the set of instructions, when executed by the processor cause the processor to perform operations comprising:
(i) receiving multiple first requests for media content;
(ii) extracting, into a dictionary, one or more first key phrases from the multiple first requests for media content or from the media content itself;
(iii) determining that a media content delivery campaign will apply to a latent interest audience;
(iv) collecting second media content requests for media content served to the latent interest audience;
(v) determining a context for each of the second media content requests;
(vi) obtaining candidate key phrases from each of the contexts;
(vii) for each of the contexts, determining the candidate key phrases that match the one or more first key phrases in the dictionary;
(viii) storing, in a cache, a first table that maps each of the second media content requests to the matching candidate key phrases;
(ix) assigning a subset of the matching candidate key phrases to the media content delivery campaign;
(x) expanding the subset of matching candidate key phrases using semantic similarity;
(xi) storing the expanded subset of matching candidate key phrases in a second table indexed by the media content delivery campaign;
(xii) repeating the above for one or more additional media content delivery campaigns;
(xiii) receiving a new media content request that does not include an explicit user identification;
(xiv) determining, based on the new media content request, new request key phrases;
(xv) comparing the new request key phrases to expanded subset of matching candidate key phrases in the second table to determine intersections;
(xvi) selecting media content delivery campaigns where there are intersections; and
(xvii) utilizing one of the selected media content delivery campaigns to deliver media content in response to the new media content request.

12. The computer-implemented system of claim 11, wherein each of the multiple first requests for media content comprises a uniform resource locator (URL) request.

13. The computer-implemented system of claim 11, wherein each of the multiple first requests for media content comprises a request for audio or video content.

14. The computer-implemented system of claim 11, wherein the operations extracting the one or more first key phrases comprises:
extracting the one or more first key phrases off-line using a first large language model (LLM) to analyze historical media content requests to build the dictionary of key phrases.

15. The computer-implemented system of claim 11, wherein the operations further comprise:
regularly de-duplicating the one or more first key phrases in the dictionary on a predefined time period.

16. The computer-implemented system of claim 11, wherein:
the second media content requests comprise uniform resource locator (URL) requests;
the determining the context comprises crawling content of the URL in the URL request.

17. The computer-implemented system of claim 11, wherein:
the second media content requests comprise requests for audio-video content; and
the determining the context comprises obtaining transcripts of the audio-video content.

18. The computer-implemented system of claim 11, wherein the operations further comprise:
for each entry in the cache, sorting the matching candidate key phrases based on key performance index (KPI) data, wherein, based on the sorting, the subset comprises a top n matching candidate key phrases.

19. The computer-implemented system of claim 11, wherein the expanding utilizes a second LLM.

20. The computer-implemented system of claim 11, wherein the operations further comprise:
maintaining a log of the media content that is delivered using latent interest;
based on the log, providing a feedback loop to maintain media content delivery quality.
